(19) United States
(12) Patent Application Publication
(10) Pub. No.: US 2019/0032276 A1
(43) Pub. Date: Jan. 31, 2019

(54) Washable Carpet Tile

(71) Applicant: Milliken & Company, Spartanburg, SC (US)

(72) Inventors: Randall J. Smith, LaGrange, GA (US); Benjamin A. Trogdon, LaGrange, GA (US)

(21) Appl. No.: 16/152,442

(22) Filed: Oct. 5, 2018

Related U.S. Application Data
(62) Division of application No. 14/315,620, filed on Jun. 26, 2014.
(60) Provisional application No. 61/844,946, filed on Jul. 11, 2013.

(51) Int. Cl. D06N 7/00; D05C 15/04; B32B 38/00

(52) U.S. Cl. CPC D06N 7/0063; D06N 2209/1628; D06N 7/0068; D06N 7/0086; B32B 38/0004; B32B 38/0036; B32B 2471/02; B32B 2398/20; B32B 2319/00; Y02P 70/649; Y10T 428/23979; Y10T 29/49826; D06N 2205/18; D06N 2205/20; D06N 2209/16; Y10T 428/16; D06N 2211/066; D05C 15/04

(57) ABSTRACT

This invention relates to tufted floorcovering articles that are washable in commercial, industrial, and/or residential washing machines. In particular, this invention relates to modular carpet tiles that are constructed in such a way as to withstand exposure to at least one wash cycle in an automatic washing machine. The carpet tiles are designed to be soiled, washed, and re-used, thereby providing ideal end-use applications such as entryway floorcovering articles. A further advantage includes the ability to print advertising logos on the carpet tiles and easily change out the advertising logos as desired. Both features of the carpet tile of the present invention are achievable, at least in part, because the surface of the tile that contacts the floor does not require any type of adhesive in order to use the carpet tile for its intended function.

### CROSS REFERENCE TO RELATED APPLICATIONS

This application claims priority to and is a divisional of U.S. patent application Ser. No. 14/315,620, entitled “Washable Carpet Tile” which was filed on Jun. 26, 2014, which is a non-provisional of and claims priority to U.S. Provisional Patent Application No. 61/844,946, entitled “Washable Carpet Tile” which was filed on Jul. 11, 2013.

### TECHNICAL FIELD

This invention relates to tufted floorcovering articles that are washable in commercial, industrial, and/or residential washing machines. In particular, this invention relates to modular carpet tiles that are constructed in such a way as to withstand exposure to at least one wash cycle in an automatic washing machine. The carpet tiles are designed to be soiled, washed, and re-used, thereby providing ideal end-use applications such as entryway floorcovering articles. A further advantage includes the ability to print advertising logos on the carpet tiles and easily change out the advertising logos as desired. Both features of the carpet tile of the present invention are achievable, at least in part, because the surface of the tile that contacts the floor does not require any type of adhesive in order to use the carpet tile for its intended function.

### BACKGROUND

High traffic areas, such as entrances to buildings, restrooms, break areas, etc., typically have the highest carpet soiling issue. Currently, washable one-piece mats having a pile surface are found in these locations. The washable carpet tiles of the present invention are designed to replace these one-piece floor mats. The use of washable carpet tile in high traffic, highly soiled areas is pragmatic because the soiled tiles may be easily removed, laundered, and re-installed. The carpet tiles, both before and after laundering, have substantially the same pile height as the surrounding tiles and fit back onto the floor with substantially zero voids between the tiles. The washable carpet tiles are an improvement over one-piece floor mats and other floorcovering articles where normal carpet maintenance will not successfully clean the carpet.

### BRIEF SUMMARY

In one aspect, the invention relates to a washable carpet tile comprising a first layer of pile face yarns, a second layer of nonwoven material, and a third layer of vulcanized rubber; wherein the carpet tile has dimensions in the range from 4 inches by 4 inches to 72 inches by 72 inches; and wherein the carpet tile can withstand at least one wash cycle in a commercial or residential washing machine whereby the carpet tile is suitable for re-use after exposure to the at least one wash cycle.

In another aspect, the invention relates to a washable carpet tile comprising a first layer of pile face yarns, a second layer of nonwoven material, and a third layer of vulcanized rubber; wherein the carpet tile has been exposed to a wash procedure that effectively pre-shrinks the edge dimensions of the carpet tile by an amount in the range from 0.001% and 5.0%; and wherein the carpet tile can withstand at least one wash cycle in a commercial or residential washing machine whereby the carpet tile is suitable for re-use after exposure to the at least one wash cycle.

In yet a further aspect, the invention relates to a process for making a washable carpet tile, said process comprising the steps of tufting face yarns into a nonwoven primary backing material to form a face composite, optionally printing the face composite, providing a layer of unvulcanized rubber, adhering the face composite to the layer of unvulcanized rubber via a rubber vulcanization process to form a washable carpet tile having a vulcanized rubber backing, pre-shrinking the carpet by exposure to heat and cutting the carpet into carpet tiles.

In another aspect, the invention relates to a carpet system comprising: (1) at least one floorcovering article comprised of a plurality of pile yarns tufted into a primary backing layer; a secondary backing layer; and a polyurethane foam layer; and (2) at least one washable carpet tile comprised of a plurality of pile yarns tufted into a primary backing layer; and a layer of vulcanized rubber; wherein the at least one washable carpet tile has dimensions in the range from 4 inches by 4 inches to 72 inches by 72 inches; and wherein the at least one washable carpet tile can withstand at least one wash cycle in a commercial or residential washing machine whereby the at least one washable carpet tile is suitable for re-use after exposure to the at least one wash cycle; and wherein the at least one floorcovering article forms a border within which the at least one washable carpet tile is inserted.

In a further aspect, the invention relates to a method for advertising a business comprising the steps of: (1) providing a floor space; (2) providing a carpet system, wherein the carpet system is comprised of (a) at least one floorcovering article comprised of a plurality of pile yarns tufted into a primary backing layer, a secondary backing layer, and a polyurethane foam layer; and (b) at least one washable carpet tile comprised of a plurality of pile yarns tufted into a primary backing layer, and a layer of vulcanized rubber; wherein the at least one washable carpet tile has dimensions in the range from 4 inches by 4 inches to 72 inches by 72 inches; wherein the at least one washable carpet tile can withstand at least one wash cycle in a commercial or residential washing machine whereby the at least one washable carpet tile is suitable for re-use after exposure to the at least one wash cycle; and wherein the at least one washable carpet tile contains a logo, a pattern, a solid color, or mixtures thereof; and wherein the at least one floorcovering article forms a border within which the at least one washable carpet tile is inserted; (3) installing the carpet system on the floor space; and (4) allowing the carpet system to be viewed by passersby.

### BRIEF DESCRIPTION OF THE DRAWINGS

FIG. 1 is a diagram cross section of one embodiment of the washable carpet tile according to the present invention.

FIG. 2 is a diagram cross section of a standard carpet tile.

FIG. 3 is a schematic drawing of the carpet system according to the present invention that includes a combination of standard carpet tile, washable carpet tile, and an advertising logo.

FIG. 4A is a schematic drawing of the smooth rubber backing of Example 5.

FIG. 4B is a schematic drawing of the gripper (standard cleat) rubber backing of Example 6.

FIG. 4C is a schematic drawing of the Megahold rubber backing of Example 7.

FIG. 5 is a bar graph illustrating the differences in rubber backing and their effect on carpet tile movement.

### DETAILED DESCRIPTION

The term “floorcovering article,” as used herein, is intended to describe a textile substrate which comprises face fibers and which is utilized to cover surfaces on which people are prone to walk. Thus, carpets (broadloom, tile, or otherwise) and floor mats (outdoor, indoor, and the like) are specific types of floorcovering articles.

Carpet tiles may be cut into sizes in the range from 4 inches by 4 inches to 72 inches by 72 inches. The carpet tiles may be of the same length and width, thus forming a square shape. Or, the carpet tiles may have different dimensions such that the width and the length are not the same. For example, the carpet tiles may be a rectangular shape.

The present invention described herein is a washable carpet tile. The washable carpet tile is comprised of yarn tufted into fabric, which is then injection or fluid dyed, and then bonded with a rubber or washable latex backing. In one aspect, the carpet yarn is nylon 6; nylon 6,6; polyester; or polypropylene. The yarn is tufted into a woven or nonwoven substrate. The yarn can be of any pile height and weight necessary to support printing. The tufted carpet may be printed using any print process. In one aspect, injection dyeing may be utilized to print the washable carpet tiles.

After printing, the carpet is vulcanized with a rubber backing. The thickness of the rubber will be such that the height of the finished carpet tile will be substantially the same height as the surrounding standard carpet tiles. Once vulcanized, the carpet is pre-shrunk by washing.

The pre-shrunk carpet is then cut into carpet tiles. The carpet tiles may be cut using a computer controlled cutting device, such as a Gerber machine, or by using a mechanical dye cutter. The carpet should be cut with precision such that the carpet tiles fit in place with the surrounding standard carpet tiles. The finished washable carpet tiles may then be removed from the floor after they have been soiled, washed, and placed back on the floor.

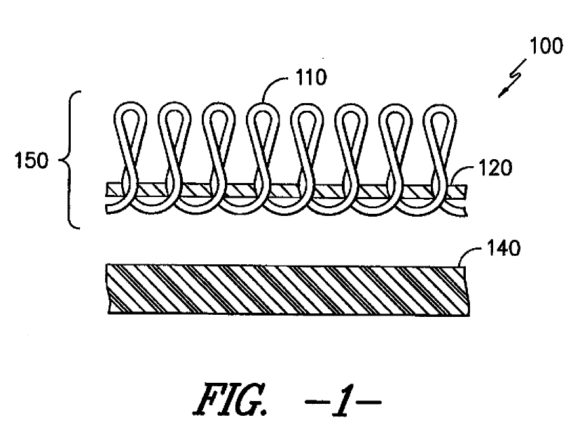

In one aspect, the washable carpet tile of the present invention is shown in FIG. 1. The washable carpet tile 100 is comprised of a plurality of face yarns 110 that are tufted into a primary backing fabric 120. The face yarns 110 and primary backing fabric 120 together comprise a primary composite layer 150. A rubber layer 140 is then vulcanized to the primary composite layer 150. The layer of vulcanized rubber may contain 0% to 10% recycled rubber material.

The material comprising the face yarns 110 and primary backing fabric 120 may independently be selected from synthetic fiber, natural fiber, man-made fiber using natural constituents, inorganic fiber, glass fiber, and a blend of any of the foregoing. By way of example only, synthetic fibers may include polyester, acrylic, polyamide, polyolefin, polyaramid, polyurethane, or blends thereof. More specifically, polyester may include polyethylene terephthalate, polytrimethylene terephthalate, polybutylene terephthalate, polylactic acid, or combinations thereof. Polyamide may include nylon 6, nylon 6,6, or combinations thereof. Polyolefin may include polypropylene, polyethylene, or combinations thereof. Polyaramid may include poly-p-phenyleneteraphthalamide (i.e., Kevlar®), poly-m-phenyleneteraphthalamide (i.e., Nomex®), or combinations thereof. Exemplary natural fibers include wool, cotton, linen, ramie, jute, flax, silk, hemp, or blends thereof. Exemplary man-made materials using natural constituents include regenerated cellulose (i.e., rayon), lyocell, or blends thereof.

The material comprising the face yarns 110 and primary backing fabric 120 may be formed from staple fiber, filament fiber, slit film fiber, or combinations thereof. The fiber may be exposed to one or more texturing processes. The fiber may then be spun or otherwise combined into yarns, for example, by ring spinning, open-end spinning, air jet spinning, vortex spinning, or combinations thereof. Accordingly, the material comprising the face yarns 110 and primary backing fabric 120 will generally be comprised of interlaced fibers, interlaced yarns, loops, or combinations thereof.

The material comprising the face yarns 110 and primary backing fabric 120 may be comprised of fibers or yarns of any size, including microdenier fibers or yarns (fibers or yarns having less than one denier per filament). The fibers or yarns may have deniers that range from less than about 0.1 denier per filament to about 2000 denier per filament or, more preferably, from less than about 1 denier per filament to about 500 denier per filament.

Furthermore, the material comprising the face yarns 110 and primary backing fabric 120 may be partially or wholly comprised of multi-component or bi-component fibers or yarns in various configurations such as, for example, islands-in-the-sea, core and sheath, side-by-side, or pie configurations. Depending on the configuration of the bi-component or multi-component fibers or yarns, the fibers or yarns may be splittable along their length by chemical or mechanical action.

Additionally, the fibers comprising the material comprising the face yarns 110 and primary backing fabric 120 may include additives coextruded therein, may be precoated with any number of different materials, including those listed in greater detail below, and/or may be dyed or colored to provide other aesthetic features for the end user with any type of colorant, such as, for example, poly(oxyalkylenated) colorants, as well as pigments, dyes, tints, and the like. Other additives may also be present on and/or within the target fiber or yarn, including antistatic agents, brightening compounds, nucleating agents, antioxidants, UV stabilizers, fillers, permanent press finishes, softeners, lubricants, curing accelerators, and the like.

The fibers may be dyed or undyed. If the fiber is dyed, it may be solution dyed. The face weight of the yarn, pile height, and density will vary depending on the desired aesthetics and performance requirements of the end-use floorcovering article.

The primary backing fabric 120 can be any suitable primary backing. The preferred embodiment uses a nonwoven polyester spunbond. In one aspect, the polyester spunbond backing is Lutradur® from Freudenberg Nonwovens of Weinheim, Germany. In another aspect, flat woven polyester tapes, such as Isis™ from Propex of Chattanooga, Tenn., may be utilized. If needed, a primary backing made of a woven tape with either staple fibers or nonwoven fabrics affixed can be used. Also stitch bonded and knitted polyester fabrics may be used.

The primary composite layer 150 that includes the yarns tufted into the primary backing may be heat stabilized to prevent dimensional changes from occurring in the finished carpet tile. The heat stabilizing or heat setting process typically involves applying heat to the material that is above the glass transition temperature, but below the melting temperature of the components. The heat allows the polymer components to release internal tensions and allows improvement in the internal structural order of the polymer chains. The heat stabilizing process can be carried out under tension or in a relaxed state. The tufted composite material is typically also stabilized to allow for the yarn and primary backing to shrink prior to the tile manufacturing process. Heat stabilization further aids in preventing the edges of the finished tile from curling. Dimensional stability may be measured using the Aachen Test (ISO 2551).

The rubber layer 140 may be selected from dense nitrile rubber, foam nitrile rubber, or mixtures thereof.

The unvulcanized rubber layer is applied during the pressing process. The coated and laminated floorcovering article may then be pre-shrunk and cut into individual carpet tiles.

The washable carpet tile of the present invention may be dyed or printed by techniques known to those skilled in the art. Printing inks will contain at least one dye. Dyes may be selected from acid dyes, direct dyes, reactive dyes, cationic dyes, disperse dyes, and mixtures thereof. Acid dyes include azo, anthraquinone, triphenyl methane and xanthine types. Direct dyes include azo, stilbene, thiazole, dioxsazine and phthalocyanine types. Reactive dyes include azo, anthraquinone and phthalocyanine types. Cationic dyes include thiazole, methane, cyanine, quinolone, xanthene, azine, and triaryl methine. Disperse dyes include azo, anthraquinone, nitrodiphenylamine, naphthal imide, naphthoquinone imide and methane, triarylmethine and quinoline types.

As is known in the textile printing art, specific dye selection depends upon the type of fiber and/or fibers comprising the washable carpet tile that is being printed. For example, in general, a disperse dye may be used to print polyester fibers. Alternatively, for materials made from cationic dyeable polyester fiber, cationic dyes may be used.

The printing process of the present invention uses a jet dyeing machine, or a digital printing machine, to place printing ink on the surface of the carpet tile in predetermined locations. One suitable and commercially available digital printing machine is the Millitron® digital printing machine, available from Milliken & Company of Spartanburg, S.C. The Millitron® machine uses an array of jets with continuous streams of dye liquor that can be deflected by a controlled air jet. The array of jets, or gun bars, is typically stationary. Another suitable and commercially available digital printing machine is the Chromojet® carpet printing machine, available from Zimmer Machinery Corporation of Spartanburg, S.C. In one aspect, a tufted carpet made according to the processes disclosed in U.S. Pat. No. 7,678,159 and U.S. Pat. No. 7,846,214, both to Weiner, may be printed with a jet dyeing apparatus as described and exemplified herein.

Viscosity modifiers may be included in the printing ink compositions. Suitable viscosity modifiers that may be utilized include known natural water-soluble polymers such as polysaccharides, such as starch substances derived from corn and wheat, gum arabic, locust bean gum, tragacanth gum, guar gum, guar flour, polygalactomannan gum, xanthan, alginates, and a tamarind seed; protein substances such as gelatin and casein; tannin substances; and lignin substances. Examples of the water-soluble polymer further include synthetic polymers such as known polyvinyl alcohol compounds and polyethylene oxide compounds. Mixtures of the aforementioned viscosity modifiers may also be used. The polymer viscosity is measured at elevated temperatures when the polymer is in the molten state. For example, viscosity may be measured in units of centipoise at elevated temperatures, using a Brookfield Thermosel unit from Brookfield Engineering Laboratories of Middleboro, Mass. Alternatively, polymer viscosity may be measured by using a parallel plate rheometer, such as made by Haake from Rheology Services of Victoria Australia.

The washable carpet tile of the present invention may be exposed to post treatment steps. For example, chemical treatments such as stain release, stain block, antimicrobial resistance, bleach resistance, and the like, may be added to the washable carpet tile. Mechanical post treatments may include cutting, shearing, and/or napping the surface of the washable carpet tile.

In FIG. 1, the face yarns are illustrated in a loop pile construction. Of course, it is to be understood that other face yarn constructions including cut pile constructions and combinations of loop pile and cut pile may likewise be used.

In modular carpet tile installation, adhesives may be used to hold the tiles to the floor. These adhesive are typically polyolefin based or SBR latex based. Such adhesive material may be used to adhere the standard carpet tile to the floor, when standard carpet tiles are used as part of the carpet system of the present invention.

As previously discussed, tufted carpet typically consists of a face yarn (staple or continuous fibers) tufted into a primary backing. The yarn provides the appearance or aesthetics of the carpet. The primary backing can be either a woven, nonwoven or knitted product which supports the tufts.

The back coating provides a moisture barrier and provides dimensional stability to the carpet tile. For standard carpet tiles, a polyurethane foam and/or nonwoven underlayer is applied to the back of the carpet.

The performance requirements for commercial carpet include a mixture of well documented standard tests and industry known tests. Resistance to Delamination of the Secondary Backing of Pile Yarn Floor Covering (ASTM D3936), Tuft Bind of Pile Yarn Floor Coverings (ASTM D1335), and the Aachen dimensional stability test (ISO 2551) are performance tests referenced by several organizations (e.g. General Services Administration). Achieving Resistance to Delamination values greater than 2 pounds is desirable, and greater than 2.5 pounds even more desirable. Achieving Tuft Bind values greater than 8 pounds is desirable, and greater than 10 pounds even more desirable. With respect to the Aachen (ISO 2551) performance test, dimensional stability of less than +/−0.1% change may be most preferred.

Pilling and fuzzing resistance for loop pile (ITTS112) is a performance test known to the industry and those practiced in the art. The pilling and fuzzing resistance test is typically a predictor of how quickly the carpet will pill, fuzz and prematurely age over time. The test uses a small roller covered with the hook part of a hook and loop fastener. The hook material is Hook 88 from Velcro of Manchester, N.H. and the roller weight is 2 pounds. The hook covered wheel is rolled back and forth on the tufted carpet face with no additional pressure. The carpet is graded against a scale of 1 to 5. A rating of 5 represents no change or new carpet appearance. A rating of less than 3 typically represents unacceptable wear performance.

An additional performance/wear test includes the Hexapod drum tester (ASTM D-5252 or ISO/TR 10361 Hexapod Tumbler). This test is meant to simulate repeated foot traffic over time. It has been correlated that a 12,000 cycle count is equivalent to ten years of normal use. The test is rated on a gray scale of 1 to 5, with a rating after 12,000 cycles of 2.5=moderate, 3.0=heavy, and 3.5=severe. Yet another performance/wear test includes the Radiant Panel Test. Some commercial tiles struggle to achieve a Class I rating, as measured by ASTM E 648-06 (average critical radiant flux>0.45=class I highest rating).

The rubber-backed carpet tile of the present invention may be washed or laundered in an industrial, commercial or residential washing machine. Because the backing is comprised of rubber, the carpet tiles may be easily rolled and wrapped for shipping without a box or a pallet, which may provide a cost savings. The washable, rubber-backed carpet tiles are ideal for use in areas having high traffic and soiling and/or in areas where advertising with business logos is desired. The advertising can be easily rotated and/or changed by replacing the center tiles that contain the logo with new tiles that contain a different advertising logo. The washable carpet tiles are also ideal for use in high traffic areas where soiling is a problem. By replacing the current floor mats with the carpet tiles of the present invention, trip hazards may be eliminated. The current floor mats have a tendency to roll up and/or wrinkle, thereby causing trip hazards. Additionally, the washable carpet tiles will generally exhibit superior cleaning when compared to similar carpet tiles cleaned with a carpet cleaning machine, such as a steam cleaning machine.

In one aspect, the washable carpet tiles described herein are used in combination with standard carpet tiles. By standard carpet tiles, it is intended to mean carpet tiles that are not washable and that do not have a rubber backing.

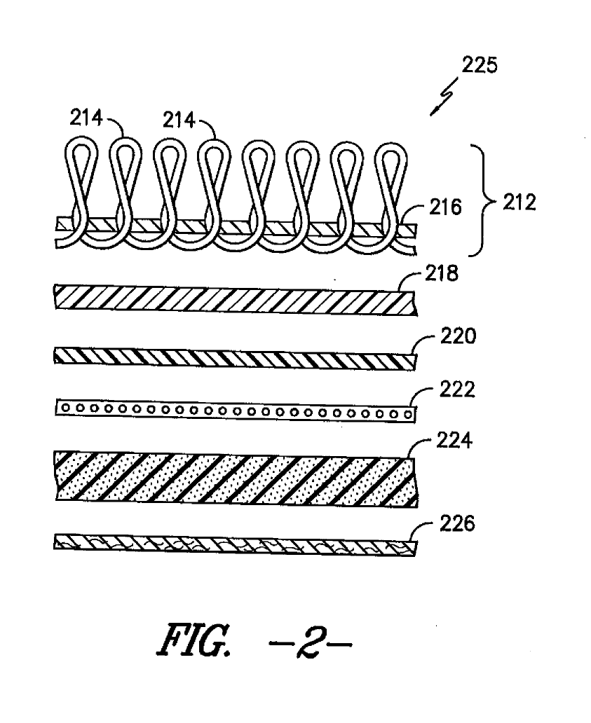

A standard carpet tile is illustrated in FIG. 2. The standard carpet tile 225 is made up of a primary carpet fabric 212 formed from a plurality of pile yarns 214 tufted through a primary backing layer 216 such as a scrim or nonwoven fibrous textile of polyester or polypropylene as will be well known to those skilled in the art. A precoat backing layer 218 of a resilient adhesive such as SBR latex is disposed across the underside of the primary carpet fabric 212 so as to hold the pile yarns 214 in place within the primary backing 216. An adhesive layer 220 such as a hot melt adhesive extends away from the precoat backing layer 218. A layer of stabilizing material 222 such as woven or nonwoven glass is disposed at a position between the adhesive layer 220 and a cushioning layer 224 such as virgin or rebounded polyurethane foam or the like. A secondary backing layer 226 such as a nonwoven blend of polyester and polypropylene fibers is disposed across the underside of the cushioning layer 224.

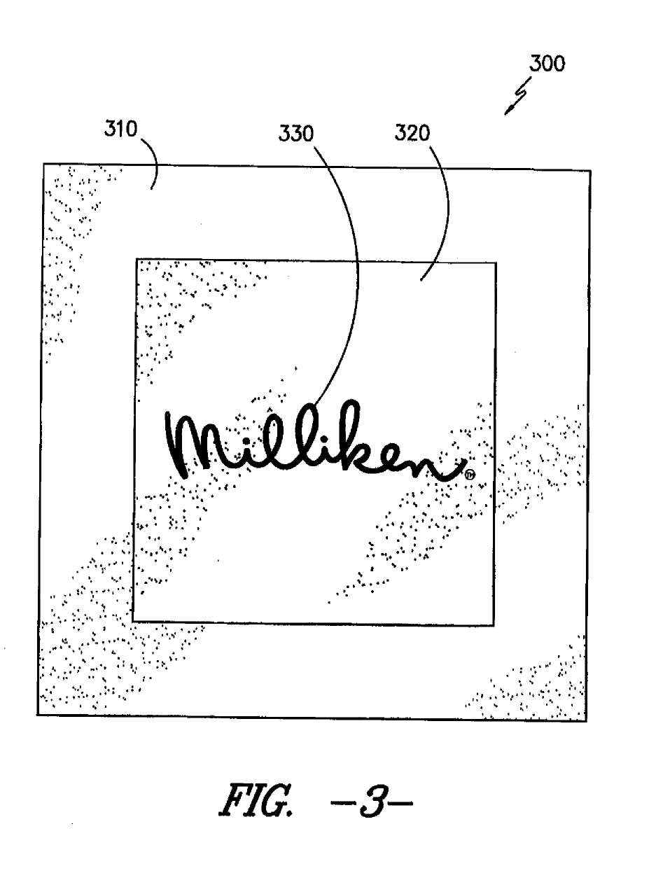

Thus, as illustrated in FIG. 3, a carpet system 300 may be created that includes a combination of at least one standard carpet tile 310, at least one washable carpet tile 320, and at least one logo, pattern, or solid face 330.

### EXAMPLES

The invention may be further understood by reference to the following examples which are not to be construed as limiting the scope of the present invention.

Several variables were tested: backing material, backing style, rubber thickness and wash process.

### Test Procedures

Commercial Wash Procedure:

1. 140 degree Fahrenheit wash for 10 minutes.

2. 3 rinses, 140 degrees, 3 minutes each.

3. 2 rinses, 90 degrees, 3 minutes each.

4. 2 minutes low extraction.

5. 10 minutes high extraction.

Some samples were evaluated on a “pass” or “fail” basis. A “pass” rating indicates that the carpet tile did not fall apart, but rather maintained its structural integrity and was suitable for use in its intended purpose. A “fail” rating indicates that one or more layers of the carpet tile came apart, that the tile did not maintain its structural integrity, and/or the carpet tile was not suitable for use in its intended purpose.

Torture Wash:

1. 190 degree Fahrenheit wash for 30 minutes.

2. 2 rinses, 90 degrees, 3 minutes each.

3. 2 minutes low extraction.

4. 10 minutes high extraction.

A Torture Wash is intended to be equivalent to 10 commercial washes.

Lateral Movement Test:

The amount of movement in a mat or carpet tile is measured using the lateral movement test. First a location on the floor is marked usually using a piece of tape. Next a mat or carpet tile is placed at that mark. For a lateral movement walk test, the person conducting the test walks over the test piece 150 times. Each pass must be in the same direction to ensure accurate measurement movement. Once this is done 150 times in the same direction, the person conducting the test must measure how far the test piece is from the original location. This should be done on both of the front corners. Once a walk test is completed, a second Lateral Movement Cart Test is run. This test involves the same process, but requires a cart holding a 100 lb. load to roll over the test piece 50 times. The distance is then measured and recorded.

Thickness Determination:

The thickness of each sample was measured using a Starrett pocket dial gauge. The specific model was the Starrett No. 1010. The pocket dial that was used came with an inspection certificate (Form 804) to ensure accuracy.

Tuft Lock Test:

The tuft lock test was conducted by cutting out a sample of finished carpet tile approximately 6″×10″. Once the sample was cut out, it was placed in a TensiTech tensile testing machine. A tensile testing program was then run allowing the machine to grasp on to a single tuft in the carpet. Once the machine locked on to a single tuft, it recorded how much force was required to pull the tuft out of the rubber backed carpet tile. This data was then recorded and run 4 more times for a total of 5 pulls. The once all tests were complete the data was evaluated making sure all pulls recorded a value higher than 4.0.

Body Tear Test:

The body tear test was conducted by cutting out a sample of finished carpet tile approximately 4″×7″ with a 2″ slit at one end of it. Once the sample was cut out, it was placed in a TensiTech tensile testing machine with one side of the slit in the top clamp, and the other side of the slit in the bottom clamp. A tensile testing program was then run pulling the top clamp upwards. The force required to pull the top clamp up was recorded as the sample ripped in half. This data was then recorded and run 2 more times for a total of 3 pulls. The once all tests were complete the data was evaluated making sure all pulls recorded a value higher than 13.0.

Evaluation of Backing Material

### Example 1—Carpet Tile with Nitrile Rubber Backing

A carpet tile was prepared as follows:

The tufted face assembly 150 was comprised of a nylon 6,6 yarn tufted into a pre-shrunk Lutrador 52 nonwoven backing. The nylon 6,6 yarn was ⅛^{th} inch gauge and was tufted at 8.70 stitches per inch. Tufts were sheared to a pile height of 18/64^{th} inch, resulting in a fabric weight of 20.0 oz/sq. yard. The tufted roll measured 145 inches from outside tuft row to outside tuft row.

The tufted roll was then printed using a Millitron® digital printing machine. The tufted face assembly was run down the Millitron® digital printing machine at a speed of 25 feet/minute. A combination of 12 gun bars was utilized to distribute dye to the tufted face assembly with the dye flow set to 36. The tufted face assembly was then exposed to a first steam step in a steamer at 209° F., and then again in a post steam/stain blocker step at 150° F. The printed tufted face assembly was then dried at 240° F.

The printed tufted face assembly was then slit into 3.2′ wide rolls. These rolls were placed on top of 0.130″ (thickness) nitrile rubber. The uncured nitrile rubber was then sent into a press with the printed tufted face assembly on top. The press heated up to 365° F. from the bottom as soon as the printed assembly entered the press area. The press then applied pressure at 35 psi to the top of the printed tufted face assembly to push it into the rubber. The printed tufted face assembly was then held in the press for 8 minutes before it was removed. After it was removed, it was preshrunk in a drier at 290° F. to form a washable carpet in roll form. The washable carpet in roll form was then cut into washable carpet tiles having dimensions of 36″×36″.

### Example 2—Carpet Tile with PVC Rubber Backing

The tufted face assembly 150 was tufted and dyed in the same manner described in Example 1. After the tufted face assembly was printed, a polyvinyl chloride rubber backing was applied. The rubber backed carpet tile was then tested for washability.

### Example 3—Carpet Tile with Rubber Crumb Backing

The tufted face assembly 150 was tufted and dyed in the same manner described in Example 1. A rubber crumb backing was applied. The rubber crumb backed carpet tile was then tested for washability.

### Example 4—Carpet Tile with Cushion Backing

A cushion backed carpet tile was prepared. It was comprised of nylon 6,6 fiber with a face weight of 23 oz/sq. yd. The fiber was twisted, heat set, and tufted into a Lutrador primary backing. The tile further consisted of 11 oz./sq. yd. of SBR and chlorinated latex blend, 46 oz./sq. yd. of bitumen hot melt, and a fiberglass layer to improve stability and performance. On the bottom of the tile was 25.5 oz./sq. yd. of polyurethane foam. All of the coating processes were complete in-line. The coated product was then printed with Milliken dye injected technology. Finally, a topical application of chemistry was applied to prevent staining and to provide repellency.

Examples 1-4 were evaluated on the ability to withstand commercial laundering. Each sample was subjected to one commercial wash cycle and evaluated as described herein. Then, the samples that passed the first evaluation were subjected to four additional commercial wash cycles (5 wash cycles total) and evaluated as described herein. The test results are provided in Table 1.

TABLE 1
Evaluation of Backing Materials After Laundering

| | After 1 Commercial | After 5 Commercial |
|---|---|---|
| Sample | Wash | Washes |
| Example 1 - Nitrile | Pass | Pass |
| Rubber Back | | |
| Example 2 - PVC Rubber | Pass | Fail |
| Back | | |
| Example 3 - Rubber | Pass | Fail |
| Crumb Back | | |
| Example 4 - Cushion | Fail | N/A |
| Back | | |

After the 1 commercial wash, the tufted face layer of Example 4 came apart from the backing. It appeared as though the adhesive holding those layers together was unable to withstand commercial washing. Example 4 was not tested again. Examples 2-4 passed the evaluation in that the layers remained adhered together, the tiles maintained their integrity, and the tiles were suitable for use in their intended purpose.

After 5 commercial washes, the PVC rubber backing of Example 2 failed. The PVC rubber cracked and broke apart on the sides. In the middle, the rubber failed causing holes in the tile. When looking at the side view of the tile, the tile had ripples in it that were over 0.5 inches high, which would cause a trip hazard. Example 2 did not maintain structural integrity; thus, it received a “fail” rating.

After 5 commercial washes, the rubber crumb backing of Example 3 failed. Pieces of rubber crumb over 1 inch long came off of the tile during the wash cycles. Example 3 did not maintain structural integrity; thus, it received a “fail” rating.

Example 1 successfully survived five commercial wash cycles. In further testing, the nitrile rubber-backed carpet tile exhibited dimensional stability and maintained a “pass” rating after 300 commercial wash cycles.

Evaluation of Backing Style

### Example 5—Smooth Nitrile Backing

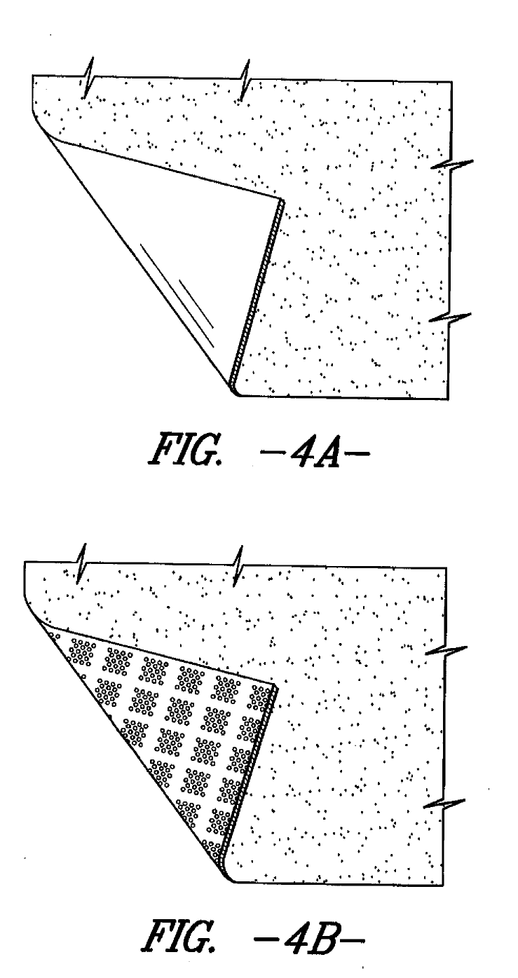

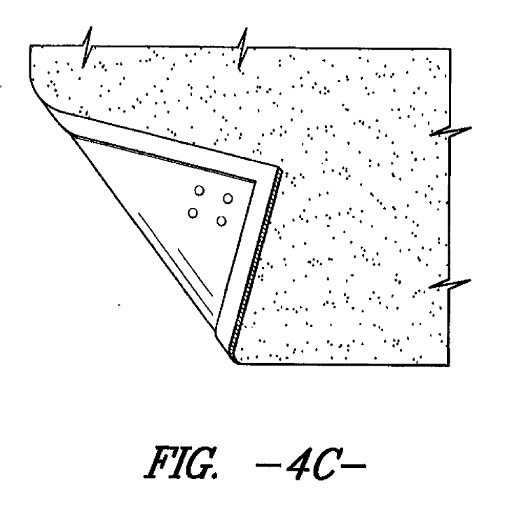

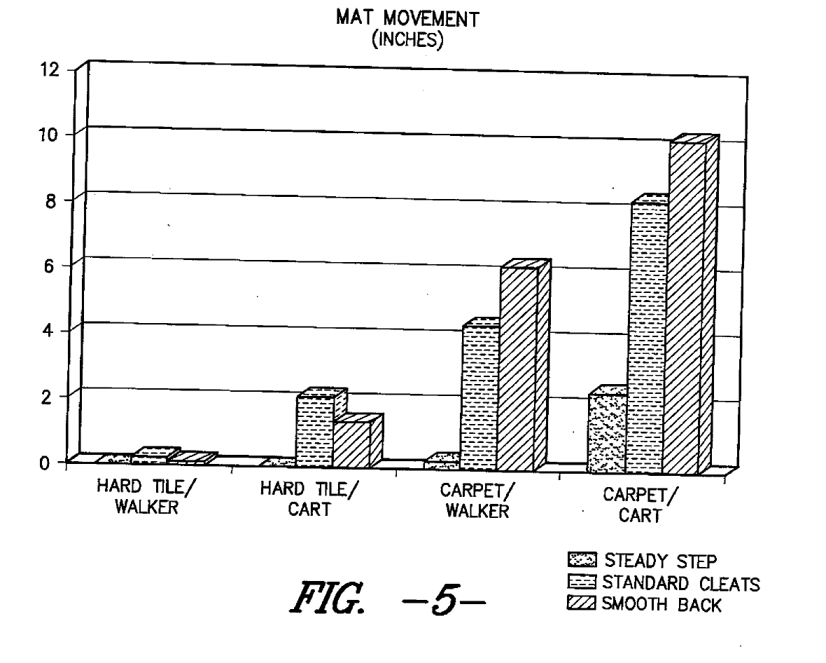

As illustrated in FIG. 4A, the smooth rubber backing has no protrusions on the rubber surface of the carpet tile (e.g. the surface of the carpet tile that comes in contact with the floor). In other words, the smooth backing is free from protrusions. Protrusions are typically added to aid in preventing unintended lateral movement of the floorcovering article.

The construction of the washable carpet tile was identical to the tile produced in Example 1. When the nitrile rubber was placed on the press, it was put on a Teflon coated belt that had no indentions in it. The top of the belt was smooth which allowed the bottom of the rubber to have a smooth surface as well.

### Example 6—Gripper (Standard Cleat) Nitrile Backing

As illustrated in FIG. 4B, the gripper rubber backing was characterized by having (1) a grid pattern on the rubber surface that was free from protrusions and (2) protrusions on the interior spaces between the protrusion free areas. The protrusions were present in a square pattern. Thus, the gripper backing contained a repeating pattern of small protrusions in areas that were ⅞^{ths} inch by 1 inch square. The protrusions were approximately 1/16^{th} inch high. The protrusions covered approximately 70 percent of the surface of the rubber backing.

The construction of the washable carpet tile was the same as the tile produced in Example 1. When the nitrile rubber was placed on the press, it was put on a Teflon coated belt that had 1/16^{th} inch indention in it in small square patterns. When the press reached 365° F., it caused the rubber to become very soft. Once the pressure of 35 psi was applied to the top of the washable tile assembly, it pushed the soft rubber into the indentions forming the “gripper” pattern.

### Example 7—Megahold Nitrile Backing

As illustrated in FIG. 4C, the Megahold rubber backing was characterized by having fewer and larger indentations on the rubber surface, when compared to the gripper backing. The indentations were present in groups of four that and were spaced in a square pattern. Thus, the Megahold pattern contained a repeating pattern of four large indentations in areas that were 3.625 inches by 3.875 inches square. The indentations were approximately ⅛ inch deep. The indentations covered approximately 40 percent of the surface of the rubber backing.

The construction of the washable carpet tile was the same as the tile produced in Example 1. Before the rubber was placed on to the Teflon belt, the operator placed a metal plate on the belt. The metal plate contained circles on the top surface. The circles included a hole drilled in the center to allow rubber to form on the inside. The nitrile rubber was then placed on top of the metal plate, with the fabric/carpet on top. When the press reached 365° F., it caused the rubber to become very soft. Once the pressure of 35 psi was applied to the top of the washable carpet tile assembly, it pushed the soft rubber around and into the metal plate forming the “Megahold” backing.

Each of the rubber types were tested on both carpet and smooth flooring according to the Lateral Movement Test described herein. Test results are provided in FIG. 5.

The same Lateral Movement Test was used to evaluate the smooth back carpet tile (Example 5) and the Megahold back carpet tile (Example 7) when placed within a border of standard carpet tiles. The test results are provided in Table 2.

TABLE 2
Carpet Tile Movement When Combined into Carpet
System with Standard Carpet Tile Border

| | Carpet Tile Movement | |
|---|---|---|
| | After 200 Pedestrian | Carpet Tile Movement |
| | Passes | After 100 Cart Passes |
| Sample | (inches) | (inches) |
| Example 5 - Smooth | 0.00 | 0.00 |
| Backing | | |
| Example 7 - Megahold | 0.00 | 0.00 |
| Backing | | |

Evaluation of Rubber Backing Thickness:

Carpet tiles having rubber backing of varying thicknesses were made. They were then evaluated for height matching against standard carpet tile. The standard carpet tile is Control 1. The thickness values were determined using the Thickness Determination procedure described herein. The results are provided in Table 3.

### Example 8—Carpet Tile (0.043″ Rubber Backing)

A washable carpet tile was made using the same nitrile rubber and smooth backing as described in Example 5 with a nitrile rubber that was calendared to 0.043″ in thickness. The fabric and backing composite layer 150 was pressed into the 0.043″ thick rubber at 360 degrees Fahrenheit under 36 PSI for 4 minutes. The washable carpet was then dried at 195 degrees Fahrenheit and cut into 36″ by 36″ tiles using a Gerber cutter.

### Example 9—Carpet Tile (0.053″ Rubber Backing)

A washable carpet tile was made using the same nitrile rubber and smooth backing as described in Example 5 with a nitrile rubber that was calendared to 0.053″ in thickness. The fabric and backing composite layer 150 was pressed into the 0.053″ thick rubber at 360 degrees Fahrenheit under 36 PSI for 5 minutes. The washable carpet was then dried at 195 degrees Fahrenheit and cut into 36″ by 36″ tiles using a Gerber cutter.

### Example 10—Carpet Tile (0.080″ Rubber Backing)

A washable carpet tile was made using the same nitrile rubber and smooth backing as described in Example 5 with a nitrile rubber that was calendared to 0.080″ in thickness. The fabric and backing composite layer 150 was pressed into the 0.080″ thick rubber at 360 degrees Fahrenheit under 36 PSI for 8 minutes. The washable carpet was then dried at 195 degrees Fahrenheit and cut into 36″ by 36″ tiles using a Gerber cutter.

### Example 11—Carpet Tile (0.130″ Rubber Backing)

A washable carpet tile was made using the same nitrile rubber and smooth backing as described in Example 5 with a nitrile rubber that was calendared to 0.130″ in thickness. The fabric and backing composite layer 150 was pressed into the 0.130″ thick rubber at 360 degrees Fahrenheit under 36 PSI for 18 minutes. The washable carpet was then dried at 195 degrees Fahrenheit and cut into 36″ by 36″ tiles using a Gerber cutter.

Control 1—Standard Carpet Tile

This carpet tile is the same as the tile described in Example 4.

TABLE 3
Total Thickness of Inventive and Control Carpet Tiles

| | Test 1 | Test 2 | Test 3 | Test 4 | Test 5 | Average |
|---|---|---|---|---|---|---|
| | Thickness | Thickness | Thickness | Thickness | Thickness | Thickness |
| Sample | (inches) | (inches) | (inches) | (inches) | (inches) | (inches) |
| Example 8 | 0.158 | 0.159 | 0.17 | 0.165 | 0.167 | 0.1638 |
| (0.043″ | | | | | | |
| backing) | | | | | | |
| Example 9 | 0.17 | 0.179 | 0.175 | 0.168 | 0.176 | 0.1736 |
| (0.053″ | | | | | | |
| backing) | | | | | | |
| Example 10 | 0.204 | 0.205 | 0.198 | 0.21 | 0.204 | 0.2042 |
| (0.080″ | | | | | | |
| backing) | | | | | | |
| Example 11 | 0.278 | 0.27 | 0.277 | 0.269 | 0.273 | 0.2734 |
| (0.130″ | | | | | | |
| backing) | | | | | | |
| Control 1 | 0.32 | 0.323 | 0.322 | 0.325 | 0.324 | 0.3228 |

Using the collected data in Table 3, the difference in height of the finished carpet tiles was calculated. This was done to determine how flush the inventive carpet tiles were to Control 1. The results are shown in Table 4.

TABLE 4
Finished Tile Height Differential

| | Thickness Differential |
|---|---|
| Sample | (inches) |
| Example 8 | −0.159 |
| (0.043″ | |
| backing) | |
| Example 9 | −0.1492 |
| (0.053″ | |
| backing) | |
| Example 10 | −0.1186 |
| (0.080″ | |
| backing) | |
| Example 11 | −0.0494 |
| (0.130″ | |
| backing) | |
| Control 1 | 0.0000 |

Evaluation of Wash Processes:

The effect of pre-washing the carpet was evaluated.

### Comparative Example 12—Carpet Tile with No Pre-Wash

A carpet tile made from the same materials as Example 11 was used, except the carpet was not exposed to a pre-wash step prior to cutting the carpet into a carpet tile. The carpet was cut into 36″ by 36″ tiles using a Gerber cross cutter. The tile was placed into a carpet system that contained a border of standard carpet tile in order to ensure cutting accuracy (i.e. a snug fit with no voids between the tiles). The tile was then washed according to the Commercial Wash Procedure. The tile was then re-inserted into the carpet system to evaluate its size. The carpet tile had shrunk by such an amount that it was not usable for its intended purpose. The gap between the carpet tile and the surrounding border of standard carpet tiles was large enough to cause a trip hazard.

### Example 12—Carpet Tile with Pre-Wash

A carpet tile made from the same materials as Example 11 was used. It was exposed to a pre-wash step prior to cutting the carpet into a carpet tile. The carpet was cut into 36″ by 36″ tiles using a Gerber cross cutter. The tile was placed into a carpet system that contained a border of standard carpet tile in order to ensure cutting accuracy (i.e. a snug fit with no voids between the tiles). The tile was then washed according to the Commercial Wash Procedure. The tile was then re-inserted into the carpet system to evaluate its size. The carpet tile exhibited no visible shrinkage. There were no gaps or voids between the carpet tile and the surrounding border of standard carpet tiles.

The impact of industrial washes on physical properties of the carpet tiles was also evaluated.

### Example 13—Exposure to 30 Torture Washes

Example 13 was the same as Example 12. The sample was exposed to 30 Torture Washes as described herein. After 30 Torture Washes, the sample exhibited no visible shrinkage. All four sides of the carpet tile lay flush against the surrounding border of standard carpet tiles with no gaps or voids present.

The carpet tile was also tested for Tuft Lock and Body Tear, according to the test methods described herein. Test results are provided in Table 5.

TABLE 5
Physical Data After 30 Torture Washes

| | |
|---|---|
| Tuft Lock | Body Tear |

| | | | |
|---|---|---|---|
| Minimum Value | 4 | Minimum | 13 |
| Test 1 | 6.5 | Test 1 | 29.9 |
| Test 2 | 4.9 | Test 2 | 28.5 |
| Test 3 | 6.1 | Test 2 | 30.5 |
| Test 4 | 4.7 | n/a | n/a |
| Test 5 | 5.5 | n/a | n/a |

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

What is claimed is:

1. A process for cleaning a carpet tile, said process comprising the steps of:
(a) Providing a washable carpet tile comprising:
(i) A first layer of pile face yarns;
(ii) A second layer of nonwoven material; and
(iii) A third layer of vulcanized rubber;
wherein the carpet tile has dimensions in the range from 4 inches by 4 inches to 72 inches by 72 inches; wherein the carpet tile has been pre-washed; and wherein the carpet tile can withstand at least one wash cycle in a commercial or residential washing machine whereby the carpet tile is suitable for re-use after exposure to the at least one wash cycle;
(b) Installing the carpet tile on a walking surface;
(c) Allowing the carpet tile to become soiled;
(d) Removing the soiled carpet tile;
(e) Laundering the carpet tile in an industrial, commercial, or residential washing machine; and
(f) Re-installing the carpet tile on a walking surface.

2. A process for making a washable carpet tile, said process comprising the steps of:
(a) Tufting face yarns into a nonwoven primary backing material to form a face composite;
(b) Optionally, printing the face composite;
(c) Providing a layer of unvulcanized rubber;
(d) Adhering the face composite to the layer of unvulcanized rubber via a rubber vulcanization process to form a washable carpet tile having a vulcanized rubber backing;
(e) Pre-shrinking the carpet by exposure to heat; and
(f) Cutting the carpet into carpet tiles.

3. A method for advertising a business comprising the steps of:
(1) providing a floor space;
(2) providing a carpet system, wherein the carpet system is comprised of
(a) at least one floorcovering article comprised of:
i. a plurality of pile yarns tufted into a primary backing layer;
ii. a secondary backing layer; and
iii. a polyurethane foam layer;
and
(b) at least one washable carpet tile comprised of:
i. a plurality of pile yarns tufted into a primary backing layer; and
ii. a layer of vulcanized rubber;
wherein the at least one washable carpet tile has dimensions in the range from 4 inches by 4 inches to 72 inches by 72 inches;
wherein the at least one washable carpet tile can withstand at least one wash cycle in a commercial or residential washing machine whereby the at least one washable carpet tile is suitable for re-use after exposure to the at least one wash cycle; and
wherein the at least one washable carpet tile contains a logo, a pattern, a solid color, or mixtures thereof;
and
wherein the at least one floorcovering article forms a border within which the at least one washable carpet tile is inserted;
(3) installing the carpet system on the floor space; and
(4) allowing the carpet system to be viewed by passersby.
